(19) United States
(12) Patent Application Publication
(10) Pub. No.: US 2016/0370500 A1
(43) Pub. Date: Dec. 22, 2016

(54) METHOD AND SERVER FOR PROVIDING ALERTS FOR RAINFALL RETURN PERIODS

(71) Applicant: J.F. Sabourin et associés Inc., Ottawa (CA)

(72) Inventors: Jean-Francois SABOURIN, Stittsville (CA); Marcel ROY, Gatineau (CA); Francis PELLETIER, Gatineau (CA); Charles MOUGEOT, Regina (CA)

(21) Appl. No.: 14/743,111

(22) Filed: Jun. 18, 2015

(51) Int. Cl. G01W 1/14; G08B 21/18; G01W 1/10

(52) U.S. Cl. CPC G01W 1/14; G01W 1/10; G08B 21/182

(57) ABSTRACT

The present disclosure relates to a method and a server for providing alerts for rainfall return periods. The server receives periodic rain intensity measurements from a pluviometer. The server compares a last received rain intensity measurement to a set of rainfall intensity-duration-frequency (IDF) curves for a location of the pluviometer and for a time window corresponding to a periodicity of the rain intensity measurements. Based on this comparison, the server provides a current return period for the location of the pluviometer. The server sends an alert to a remote terminal when a target return period is met or exceeded by the current return period. The server may also calculate a prediction of a future return period for the location of the pluviometer and send an early warning to the remote terminal based on the future return period.

### TECHNICAL FIELD

The present disclosure relates to the field of meteorology. More specifically, the present disclosure relates to a method and a server for providing alerts for rainfall return periods.

### BACKGROUND

According at a U.S. government study, due to global warming, severe storms causing extreme floods are expected to become increasingly frequent in North America. Municipal governments often need to react to flooding caused by unexpected flash floods after they have already caused significant damage.

Weather warnings obtained by conventional means, including by use of radar images, can be generally fairly accurate in predicting the severity of storms over a broad area, for example covering a metropolitan area. However, rainfall can vary significantly between fairly proximate areas. While rain intensity might be moderate at one location, another location distant by only a few kilometers may be subject to severe rain surpassing any previous condition unseen for many years. Experts in the field of meteorology refer to ‘return periods’ to express the severity of rain conditions, stating for example that ‘the amount of rain received at a given location over a given period (e.g. a few hours) has exceeded a 10-year return period’.

Rain gauges, referred to as ‘pluviometers’, provide accurate measurements of rain accumulation at a specific location. Some pluviometers are capable of autonomously transmitting rain intensity measurements to a remote site for analysis of current rainfall. While this information can be instrumental in the root-cause analysis of recent flooding events, municipal governments can only use such information after damages have already occurred. No measure can be proactively taken at the onset of uncommon weather events.

Therefore, there is a need for techniques that provide real-time rainfall return periods.

### SUMMARY

According to the present disclosure, there is also provided a method of providing alerts for rainfall return periods. A server receives periodic rain intensity measurements from a pluviometer. The server compares a last received rain intensity measurement to a set of rainfall IDF curves for a location of the pluviometer and for a time window corresponding to a periodicity of the rain intensity measurements. Based on this comparison, the server provides a current return period for the location of the pluviometer. The server sends an alert to a remote terminal when a target return period is met or exceeded by the current return period.

According to the present disclosure, there is also provided a method of providing early warnings for predicted rainfall return periods. A server receives periodic rain intensity measurements from a pluviometer. The server compares a last received rain intensity measurement to a set of rainfall IDF curves for a location of the pluviometer and for a time window corresponding to a periodicity of the rain intensity measurements. Based on this comparison, the server provides a current return period for the location of the pluviometer. The server calculates a prediction of a future return period for the location of the pluviometer based on the current return period. The server sends an early warning to a remote terminal when a target return period is met or exceeded by the prediction.

The present disclosure further provides a server for providing alerts for rainfall return periods. The server comprises a communication interface and a controller. The communication interface is operable to receive periodic rain intensity measurements from a pluviometer and to forward alerts to a remote terminal. The controller is configured to perform the following functions: compare a last received rain intensity measurement to a set of rainfall IDF curves for a location of the pluviometer and for a time window corresponding to a periodicity of the rain intensity measurements, provide a current return period for the location of the pluviometer based on the comparison of the last received rain intensity measurement to the set of rainfall IDF curves, generate an alert when at least one of one or more target return periods is met or exceeded by the current return period, and instruct the communication interface to forward the generated alert to the remote terminal.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a flowchart showing operations of a method of providing alerts for rainfall return periods and early warnings for predicted rainfall return periods according to an embodiment;

FIG. 2 is an actual set of rainfall Intensity-Duration-Frequency (IDF) curves for the Montreal Pierre Elliott Trudeau International airport, Montreal, Qc, Canada;

FIG. 3 is a schematic diagram of a network including a server for providing alerts for rainfall return periods and early warnings for predicted rainfall return periods according to an embodiment;

FIG. 4 is an example of return period alerts calculated by the server of FIG. 2 for a plurality of pluviometers, presented in tabular form; and

FIG. 5 is a graphical representation of return period alerts over a geographical area.

### DETAILED DESCRIPTION

Various aspects of the present disclosure generally address one or more of the problems of providing real-time estimates of upcoming rainfall return periods.

Generally stated and without limitation, the present disclosure introduces a method and a system that collect at short, regular intervals rain intensity measurements automatically obtained from a plurality of pluviometers, also called rain meters or rain gauges. Measurements are sent to a server. In the server, for each pluviometer, rain intensity in a last measurement period is compared to rainfall Intensity-Duration-Frequency (IDF) curves for a time window equivalent to a duration of the regular intervals. Without limitation, these intervals may be in minutes, for example five (5) minutes. Accumulated rain intensity measurements from the current and previous periods are integrated over increasing time windows forming multiples of the time intervals, and compared to rainfall IDF curves for equivalent periods. Without limitation, time spans of the integration may range from 10 minutes up to 24 hours. When a rain intensity measurement (for a single interval) crosses a rainfall IDF curve, providing a current return period, the server sends an alert to a remote terminal, for example a computer or a cellular terminal.

A prediction of the evolution of rain intensity may be calculated based on the current rain intensity measurement and, optionally, further based on recent rain intensity measurements. The prediction can be calculated at regular intervals for a near future, for example for time spans ranging from the next half hour up to the next day. When the prediction of the rain intensity crosses a rainfall IDF curve, the server may send an early warning to the remote terminal.

The following terminology is used throughout the present disclosure:
Server: in the context of the present disclosure, a server is a computer or a group of cooperating computers in a network, operating in a so-called client-server architecture.
Pluviometer: synonymous with rain gauge, rain meter, udometer and ombrometer, a pluviometer is a device that gathers and measures an amount of liquid precipitation over a set period of time.
Rainfall intensity-duration-frequency (IDF) curve: a chart (or equivalent data, for example in the form of a table) showing return periods for rainfall intensity values as a function of duration, for example in minutes or hours.
Return period: a recurrence interval providing an estimate of the likelihood of an event; in the context of the present disclosure, for example, a rain intensity of 20 mm per hour over a period of 2 hours at a given location may have a 10-year return period.
Current return period: a return period calculated according to a current rain intensity measurement.
Future return period: an estimated value of a return period for the following minutes or hours, based on a prediction.
Alert: information about a current emergency situation, provided in the form of a text message, an audio message, a visual warning, and the like.
Early warning: information about a predicted, upcoming emergency situation, provided in the form of a text message, an audio message, a visual warning, and the like.
Integration: an assembly of values providing a larger view of a concept; in the concept of the present disclosure, this is an accumulation of periodic rain intensity measurements over a time duration, or time window.
Time span: time duration covered by the integration of periodic rain intensity measurements.
Communication interface: device capable of sending and receiving electrical, optic or radio signals over a network.
Communication port: a subset of a communication interface related to an actual physical interface.
Controller: a processor, a computer, a combination of processors and/or computers, or a portion thereof, possibly including a memory, an interface, and similar components, the controller may be hard-wired for carrying a function or may comprise programmable code for carrying a function.
Timing unit: electronic module for providing timing values.
Memory: electronic module for storing information.

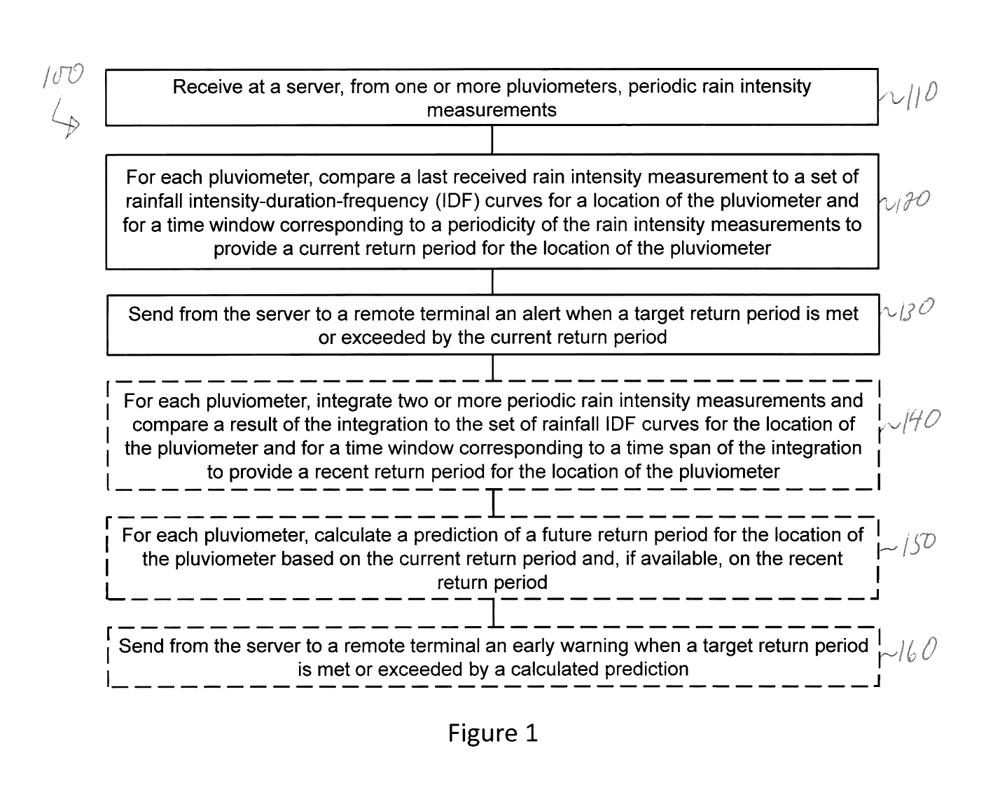

Referring now to the drawings, FIG. 1 is a flowchart showing operations of a method of providing alerts for rainfall return periods and early warnings for predicted rainfall return periods according to an embodiment. On FIG. 1, a sequence 100 comprises a plurality of operations that may be executed in variable order, some of the operations possibly being executed concurrently, some of the operations being optional. The sequence 100 includes operation 110 comprising receiving periodic rain intensity measurements from a pluviometer at a server. The server may receive such periodic rain intensity measurements from one pluviometer or from any number of pluviometers. In operation 120, for each of the pluviometers, the server compares a last received rain intensity measurement to a set of rainfall intensity-duration-frequency (IDF) curves for a location of that pluviometer and for a time window corresponding to a periodicity of the rain intensity measurements received from that pluviometer. From this comparison, the server provides a current return period for the location of that pluviometer. The server sends to a remote terminal an alert when at least one of one or more target return periods is met or exceeded by the current return period calculated for any one of the pluviometers, at operation 130.

In an embodiment, the server may integrate two or more periodic rain intensity measurements obtained from a given pluviometer at operation 140, comparing a result of the integration to the set of rainfall IDF curves for the location of the given pluviometer and for a time window corresponding to a time span of the integration to provide a recent return period for the location of that pluviometer. For example, the integration may comprise integrating the last received rain intensity measurement and any number of previously received rain intensity measurements. At operation 150, the server may calculate a prediction of a future return period for the location of that pluviometer based on the current return period and, if available, based on the recent return period. The prediction may for example be calculated based on a tendency of the two or more periodic rain intensity measurements, and/or based on an extrapolation of the last received rain intensity measurement. Alternatively or in addition, when the current return period lies between two distinct rainfall IDF curves of the set, the prediction of the future return period may be calculated by interpolation between these rainfall IDF curves. At operation 160, the server sends an early warning to a remote terminal when at least one of the one or more target return periods is met or exceeded by the prediction. The future return period is optionally included in the early warning.

The operations of the sequence 100 are usually performed on a continuous basis, the operation 110 comprising receiving periodic rain intensity measurements from a pluviometer at a server being repeated at regular intervals, for example once every 5 minutes. As a result, the alerts and early warnings can be provided in real-time or in near-real-time.

In a non-limiting embodiment, the return period may be calculated using the following equations:

$$\begin{matrix}{K}_{T} = - \frac{\sqrt{6}}{π} \{ 0.5772 + ln [ ln ( \frac{T}{T - 1} ) ] \} \\ T = \frac{1}{1 - exp \{ - exp [ - ( 0.5772 + \frac{π \cdot {K}_{T}}{\sqrt{6}} ) ] \}}\end{matrix}$$

Wherein:
T is a return period (in years) according to the Gumbel distribution law; and
K_{T} is a recurrency factor for the return period (dimensionless).

The above equations may be used to determine an interpolated return period when the current or future return period falls between two rainfall IDF curves. The same equations may also be used to determine an extrapolated return period when the current or future return period exceeds the longest return period of the set of rainfall IDF curves. It is understood that a return period value exceeding the longest return period of a given set of rainfall IDF curves may constitute a gross approximation. For example, if the set of rainfall IDF curves is defined for return periods of 2, 5, 10, 25, 50 and 100 years and if using the above equations provides a current or future return period of (say) 250 years, it will be understood that this value is only indicative of a very rare event.

It may be noted that the alert sent at operation 130 and the early warning sent at operation 160 may be sent to the same remote terminal or to distinct remote terminals. It may be further noted that the alert and the early warning may be obtained based on the same or on distinct return periods.

Operations 110-160 may all be performed for any number of pluviometers. For example, periodic rain intensity measurements may be received from a plurality of pluviometers and corresponding alerts or early warnings may be sent by the server when at least one of the one or more target return periods is met or exceeded by a corresponding current return period or by a prediction of a corresponding future return period for any one of the plurality of pluviometers. If desired, some operations may be performed for all pluviometers forwarding periodic rain intensity measurements to the server while some other operations may be performed for any subset of those pluviometers.

Because the rain intensity measurements received at the server are periodic, the server may repeatedly determine that one of the target return periods is met or exceeded by the current return period calculated at operation 120, or by a prediction of a future return period calculated at operation 150. In a variant of the sequence 100, the server may silently discard a new alert or a new early warning when an alert or an early warning has previously been sent to the remote terminal for a same target return period, for the same pluviometer. In the same or another variant, the server may arrange to display successive alerts on a web site or by similar means. In any case, the server may however send a plurality of successive alerts or early warnings when successive current return periods or successive predictions meet or exceed a plurality of distinct target return periods. A variant in which successive alerts or early warning are sent by the server for the same pluviometer and for the same target return period is also contemplated.

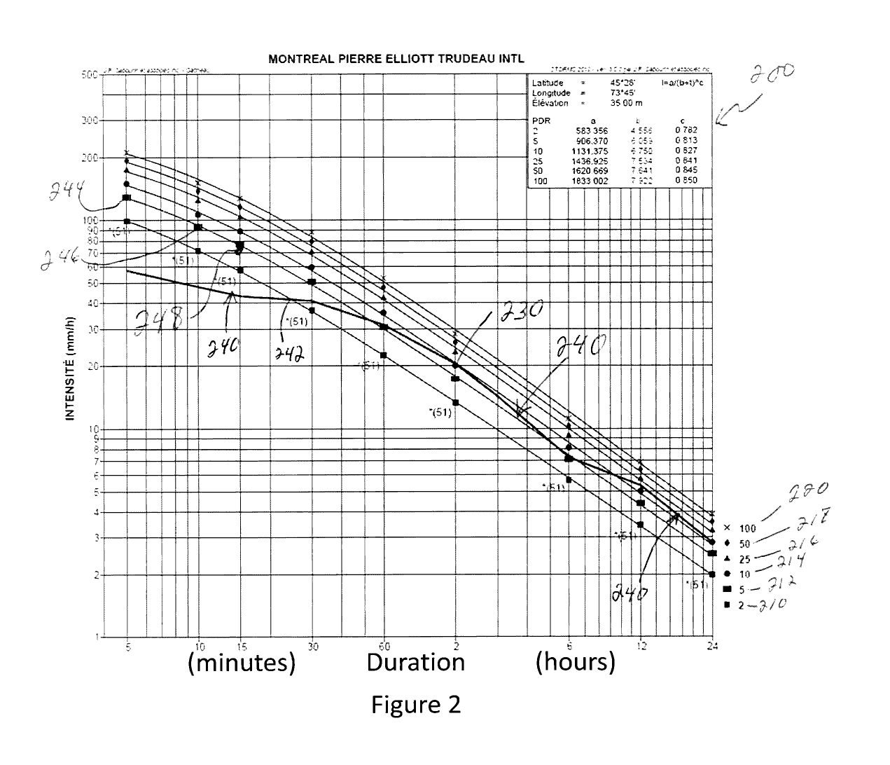

FIG. 2 is an actual set of rainfall Intensity-Duration-Frequency (IDF) curves for the Montreal Pierre Elliott Trudeau International airport, Montreal, Qc, Canada. On a chart 200, a vertical axis 202 shows rainfall intensity, in millimeters (mm) per hour. A horizontal axis 204 shows rainfall durations in minutes, in a range from 5 to 60 minutes, or in hours, in a range from 2 to 24 hours. Rainfall IDF curves 210-220 respectively provide return periods of 2, 5, 10, 25, 50 and 100 years as a function of rainfall intensity. For example, point 230 on a 10-year rainfall IDF curve 214 illustrates that a rainfall intensity of 20 mm per hour having a duration of 2 hours is expected to occur at the Montreal Pierre Elliott Trudeau International airport once every 10 years. The return period for this rainfall intensity of 20 mm per hour lasting for 2 hours is therefore 10 years.

Curve 240 is an actual plot of rainfalls occurring during June 2014 at the Montreal Pierre Elliott Trudeau International airport. The rainfall IDF curve 210 for a 2-year return period is first crossed at point 242, when a rain intensity of about 42 mm per hour was sustained for a period of about 25 minutes. Point 230, which is on the curve 240, represents the highest return period reached in the course of obtaining the data of FIG. 2, the return period being 10 years at that time.

The set of rainfall IDF curves of FIG. 2 set provides historical return periods for 2, 5, 10, 25, 50 and 100 years, each of which may form a target return period considered at operations 130 and 160 of FIG. 1. The skilled reader will appreciate that the format, rainfall intensity range and time duration range shown on FIG. 2 are for purposes of illustration and do not limit the present disclosure. The data shown on FIG. 2 could be presented in tabular form or in any equivalent form, and could include a smaller or larger set of rainfall IDF curves.

Considering the set of rainfall IDF curves of FIG. 2, which covers a large airport where more than one pluviometer may be located, the set may be common to two or more pluviometers that provide periodic rain intensity measurements to the server. Alternatively, distinct sets of rainfall IDF curves may be defined for distinct pluviometers, depending on their location.

Table 1 provides a current return result computation example based on an actual rain event.

TABLE 1
\grave{ }

| Time | 5 min | 10 min | 15 min | | 24 hours |
|---|---|---|---|---|---|
| (min) | (mm) | (mm) | (mm) | . . . | (mm) |
| 5 | 3 | — | — | . . . | — |
| 10 | 5 | 8 | — | . . . | — |
| 15 | 10 | 15 | 18 | . . . | — |
| 20 | 0 | 10 | 15 | . . . | — |
| 25 | 0 | 0 | 10 | . . . | — |
| . . . | . . . | . . . | . . . | . . . | . . . |
| Max | 10 | 15 | 18 | . . . | 18 |
| (mm) | | | | | |
| Time | 0.083 | 0.167 | 0.250 | . . . | 24 |
| (hours) | | | | | |
| Intensity | 120 | 90 | 72 | . . . | 0.75 |
| (mm/h) | | | | | |

Table 1 shows in the leftmost column that measurements are obtained from a pluviometer at 5, 10, 15, 20 and 25 minutes from the start of a 24-hour period. Other rows for pluviometer measurements obtained after 25 minutes are not shown for simplicity. Measurements for each 5-minute period are provided in a second column, in millimeters of rain. For longer periods, values are obtained by integrating data from the second column. For example, the 10-minute column shows that, after a first 10-minute period, a total of 8 mm was measured, based on the sum of a first 5-minute period showing a 3 mm accumulation and a second 5-minute period showing a 5 mm accumulation. Other columns for longer integration periods beyond 15 minutes are not shown for simplicity. The last three (3) rows summarize the data in terms of maximum intensity over a duration expressed in hours.

In the example of Table 1, the rain stopped after 15 minutes and there was no rain for the remainder of the 24-hour period. Given that 10 mm of rain was measured over a single 5-minute period, the rainfall intensity for that period was 120 mm per hour. Given that 18 mm of rain was measured in total, the average intensity over the 24-hour period was 0.75 mm per hour.

These values may be compared to a set of rainfall IDF curves for the location of the pluviometer having provided these measurements to determine corresponding return periods. For instance, assuming that the pluviometer having provided the values of Table 1 is located at the Montreal Pierre Elliott Trudeau International airport, the 120 mm per hour intensity for one 5-minute period would signal a return period of about 5 years, indicated at point 244 on FIG. 2, the 90 mm per hour intensity for one 10-minute period would correspond nearly to a return period of 5 years, as indicated at point 246 on FIG. 2, and the 72 mm per hour intensity for one 15-minute interval corresponds to a return period between 2 and 5 years, as indicated at point 248 on FIG. 2.

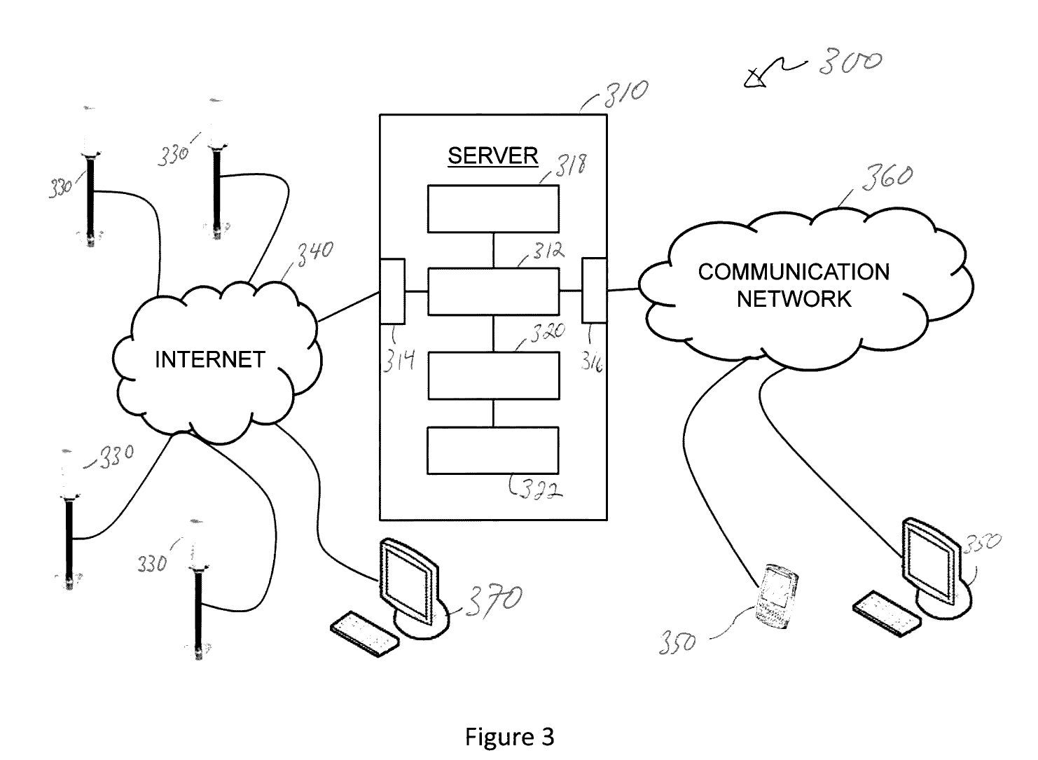

FIG. 3 is a schematic diagram of a network including a server for providing alerts for rainfall return periods and early warnings for predicted rainfall return periods according to an embodiment. A network 300 includes a server 310 interconnected with pluviometers 330 via a sub-network, for example the Internet 340 and with remote terminals 350 via the same subnetwork or, as illustrated, via another sub-network, for example a communication network 360 such as a local network or a cellular network.

The server 310 includes a controller 312 connected to a communication interface having a first port 314 and a second port 316. The controller 312 is also connected to a timing unit 318, to a memory 320 and, optionally, to a graphical user interface (GUI) 322. The GUI 322 may include a local display (not shown) co-located with the server 310. Alternatively, the GUI 322 may comprise a module that formats information for display by one of the remote terminals 350.

The server 310 receives receive periodic rain intensity measurements from a pluviometer 330 or, as shown, from a plurality of pluviometers 330 that send their measurements to the server 310 via the Internet 340. The measurements are received at the first port 314 and provided to the controller 312. For a given pluviometer 330, the controller 312 compares a last received rain intensity measurement to a set of rainfall IDF curves for a location of the given pluviometer 330 and for a time window corresponding to a periodicity of the rain intensity measurements. The set of rainfall IDF curves may be stored permanently or semi-permanently in the memory 320. Based on this comparison, the controller 312 provides a current return period for the location of the given pluviometer 330 based on the comparison of the last received rain intensity measurement to the set of rainfall IDF curves. The controller 312 generates an alert when at least one of one or more target return periods is met or exceeded by the current return period, that is, when the current return period crosses one of the rainfall IDF curves. The controller 312 also instructs the second port 312 to forward the generated alert to one or more of the remote terminals 350, via the communication network 360. The controller 312 may also calculate a prediction of a future return period for the location of the given pluviometer 330 based on the current return period. The controller 312 then generates an early warning when at least one of the one or more target return periods is met or exceeded by the prediction and instructs the second port 312 to forward the generated early warning to one or more of the remote terminal, via the communication network 360. The remote terminal or terminals 350 receiving the early warning is not necessarily the same as the one or those having received the alert.

The controller 312 may use timing information obtained from the timing unit 318 to integrate two or more periodic rain intensity measurements received from the given pluviometer 330. The last received rain intensity measurement for the current and previous rain intensity measurements for the given pluviometer 330 may be stored in the memory 320. The controller 312 may then compare a result of the integration to the set of rainfall IDF curves for the location of the given pluviometer 330 and for a time window corresponding to a time span of the integration. This allows the controller 312 to provide a recent return period for the location of the given pluviometer 330 and to calculate the prediction of the future return period for the location of the given pluviometer 330 based on the current and recent return periods. In a non-limiting example, the pluviometers forward their rain intensity measurements at 5-minute intervals and the controller 312 integrates the periodic rain intensity measurements over periods ranging from 10 minutes to 24 hours.

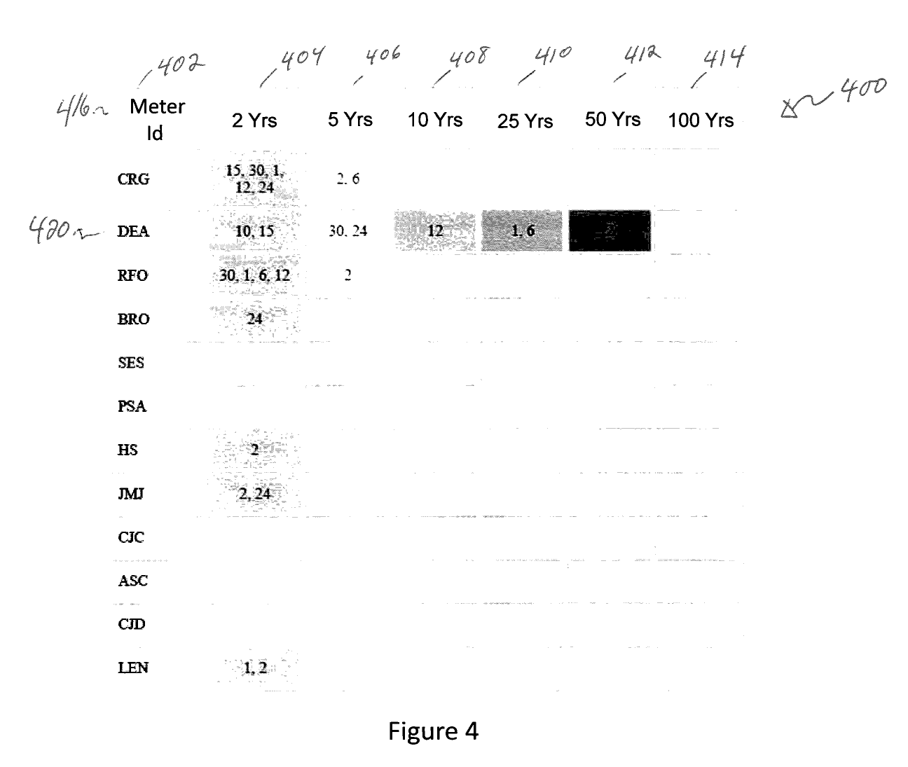

The controller 312 may format the current return periods or the predictions of future return periods for presentation in tabular form by the GUI 322. FIG. 4 is an example of return period alerts calculated by the server of FIG. 2 for a plurality of pluviometers, presented in tabular form. In a table 400, a first column 402 provides a list of identities for several pluviometers 330. Columns 404-414 indicate when a current return period (or a future return period, as the format of the table 400 is the same for current or future return periods) of 2, 5, 10, 25, 40 or 100 years, respectively, is met. In each entry of the table, other than in a top row 416, numerical values indicate which return period has been met or exceeded for a given duration. Durations are expressed in minutes when the shown values are multiples of 5 (5, 10, 15, 30 or 60 minutes), or in hours otherwise (2, 6, 12 or 24 hours).

Considering for example row 420, for a pluviometer 330 identified as “DEA”, the 2-year return period has been met or exceeded for 10- and 15-minute durations. The 5-year return period has been met or exceeded for a 30-minute duration and for a 24-hour duration. The 10-year return period has been met or exceeded for a 12-hour duration. The 25-year return period has been met or exceeded for 1- and 6-hour durations. Finally, the 50-year return period has been met or exceeded for a 2-hour duration.

It will be appreciated that the format of the table 400, of its entries and of any values therein are for illustration purposes and do not limit the present disclosure.

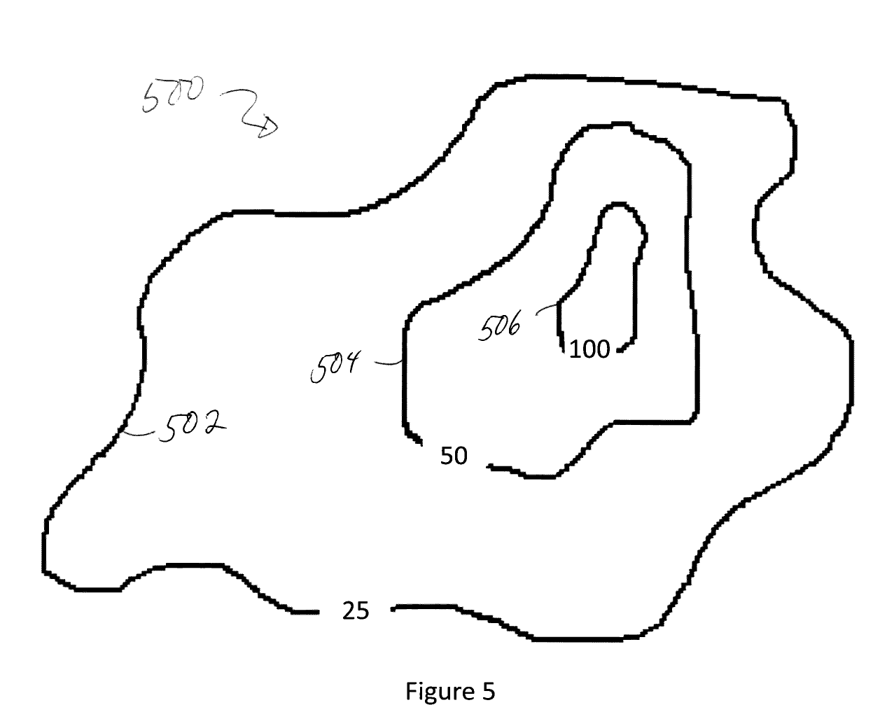

The controller 312 may format the current return periods or the predictions of future return periods for presentation in tabular form by the GUI 322. FIG. 5 is a graphical representation of return period alerts over a geographical area. Based on the location of each of the pluviometers 330 on a geographical map and based on calculated current return periods, a graph 500 includes contour lines 502, 504 and 506 respectively represent geographical regions where 25-, 50- and 100-year return periods have been met or exceeded for a selected duration of 5, 10, 15 or 30 minutes or 1, 2, 6, 12 or 24 hours. The format of the graph 500 is also applicable to show predicted future return periods. This graphical representation may be animated to show how the contour lines progress for 5-, 10-, 15- and 30-minute durations and for 1-, 2-, 6-, 12- and 24-hour durations. Though not shown on FIG. 5, the graphical representation may illustrate reference points present in the geographical area, including buildings, roads, rivers, lakes, mountains, valleys, and the like.

A weather station 370 may forward weather-related radar images to the server 310 over one of the sub-networks 340 or 360 or via any communication media. The radar images are received on one of the ports 314 or 316 and provided to the controller 312. The controller may optionally calibrate the radar images based on the periodic rain intensity measurements and generate images providing return period information. The radar images are calibrated based on the pluviometer measurements based on a weight associated with a distance between a given pluviometer and a given point of the radar image. The weight may be determined based on Thiessen polygon between the given pluviometer and the given point on the radar image. Once the weights iare determined, it becomes possible to apply a correction factor to the radar image that reflects the influence the various pluviometers. The GUI 322 formats the images for presentation by a local display (not shown) or by the remote terminals 350.

In an embodiment, the server 310 may further receive successive wind intensity measurements via one of the ports 314 or 316. The wind intensity measurements may, without limitation, be received at the same rate as the periodic rain intensity measurements. The server 310 may accumulate the successive wind intensity measurements to issue a wind-related alert when an average of a predetermined number of the successive wind intensity measurements exceeds a predetermined threshold. In more details, a distinction is made between short-duration wind gusts and sustained winds that may last for minutes or even hours. An operator of the server 310 defines the predetermined threshold value for issuance of the wind-related alert. This threshold may be expressed in knots, in miles per hour, in kilometers per hour, or based on the Beaufort scale, and is stored in the memory 320. Real-time or near real-time wind intensity measurements are received periodically at the server 310 and accumulated in the memory 320. The server 310 compares each wind intensity measurement with the threshold. The wind-related alert is issued when a predetermined and configurable number of successive measurements, for example five (5) successive measurements, exceed the predetermined threshold. The server 310 may provide at longer regular intervals, for example daily, expressing that strong winds of short duration have been measured and stored in the memory 320.

In the same or another embodiment, the server 310 may also receive receive snow accumulation measurements. The controller 312 may optionally adapt a received rain intensity measurement by applying a conversion factor to the snow accumulation measurement. Table 2 provides examples of conversion factors, or ratios, between snow depth measurements and equivalent rainfall for various types of snow.

TABLE 2

| Snow Type | Ratio Range | Average Ratio |
|---|---|---|
| Very heavy | ≦5.5:1 | 4:1 |
| Heavy | 5.6-8.5:1 | 7:1 |
| Normal | 8.6-12.5:1 | 10:1 |
| Light | 12.6-17.5:1 | 15:1 |
| Very light | 17.6-22.5:1 | 20:1 |
| Ultra light | ≧22.6:1 | 25:1 |

The conversion factors of Table 2 are provided for illustration and do not limit the present disclosure. Other factors may apply depending on local climate conditions.

In an embodiment, the server 310 may further be configured to perform all operations of the server mentioned in the description of the sequence 100.

Those of ordinary skill in the art will realize that the description of the method and server for providing alerts for rainfall return periods are illustrative only and are not intended to be in any way limiting. Other embodiments will readily suggest themselves to such persons with ordinary skill in the art having the benefit of the present disclosure. Furthermore, the disclosed method and server may be customized to offer valuable solutions to existing needs and problems of providing real-time estimates of upcoming rainfall return periods.

In the interest of clarity, not all of the routine features of the implementations of method and server for providing alerts for rainfall return periods are shown and described. It will, of course, be appreciated that in the development of any such actual implementation of the method and server, numerous implementation-specific decisions may need to be made in order to achieve the developer's specific goals, such as compliance with application-, system-, network- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of meteorology having the benefit of the present disclosure.

Systems and modules described herein may comprise software, firmware, hardware, or any combination(s) of software, firmware, or hardware suitable for the purposes described herein. Software and other modules may reside on servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

What is claimed is:

1. A method of providing alerts for rainfall return periods, comprising:
receiving at a server, from a pluviometer, periodic rain intensity measurements;
in the server, comparing a last received rain intensity measurement to a set of rainfall intensity-duration-frequency (IDF) curves for a location of the pluviometer and for a time window corresponding to a periodicity of the rain intensity measurements to provide a current return period for the location of the pluviometer; and
sending from the server to a remote terminal an alert when at least one of one or more target return periods is met or exceeded by the current return period.

2. The method of claim 1, comprising:
in the server, calculating a prediction of a future return period for the location of the pluviometer based on the current return period; and
sending from the server to a remote terminal an early warning when at least one of the one or more target return periods is met or exceeded by the prediction.

3. The method of claim 2, comprising:
in the server, integrating two or more periodic rain intensity measurements and comparing a result of the integration to the set of rainfall IDF curves for the location of the pluviometer and for a time window corresponding to a time span of the integration to provide a recent return period for the location of the pluviometer;
wherein the calculation of the prediction of the future return period for the location of the pluviometer is based on the current and recent return periods.

4. The method of claim 3, wherein integrating the two or more periodic rain intensity measurements comprises integrating the last received rain intensity measurement and at least one previous rain intensity measurement.

5. The method of claim 3, comprising calculating the prediction of the future return period based on a tendency of the two or more periodic rain intensity measurements.

6. The method of claim 2, comprising calculating the prediction of the future return period based on an extrapolation of the last received rain intensity measurement.

7. The method of claim 2, comprising:
calculating the prediction of the future return period by interpolation when the current return period lies between two distinct rainfall IDF curves of the set; and
including the future return period in the early warning.

8. The method of claim 2, comprising receiving at the server periodic rain intensity measurements from a plurality of pluviometers and sending a corresponding early warning when at least one of the one or more target return periods is met or exceeded by a corresponding prediction for any one of the plurality of pluviometers.

9. The method of claim 1, comprising receiving at the server periodic rain intensity measurements from a plurality of pluviometers and sending a corresponding alert when at least one of the one or more target return periods is met or exceeded by a corresponding current return period for any one of the plurality of pluviometers.

10. The method of claim 9, wherein distinct sets of rainfall IDF curves are defined for distinct pluviometers.

11. The method of claim 9, wherein a common set of rainfall IDF curves is used for two or more pluviometers.

12. The method of claim 1, wherein each rainfall IDF curve of the set provides historical return periods selected from the group consisting of 2, 5, 10, 25, 50 and 100 years.

13. The method of claim 1, wherein the target return period is selected from the group consisting of 2, 5, 10, 25, 50 and 100 years.

14. The method of claim 1, comprising sending a plurality of successive alerts when successive current return periods meet or exceed a plurality of distinct target return periods.

15. The method of claim 1, comprising silently discarding a new alert when an alert has previously been sent to the remote terminal for a same target return period.

16. A method of providing early warnings for predicted rainfall return periods, comprising:
receiving at a server, from a pluviometer, periodic rain intensity measurements;
in the server, comparing a last received rain intensity measurement to a set of rainfall intensity-duration-frequency (IDF) curves for a location of the pluviometer and for a time window corresponding to a periodicity of the rain intensity measurements to provide a current return period for the location of the pluviometer;
in the server, calculating a prediction of a future return period for the location of the pluviometer based on the current return period; and
sending from the server to a remote terminal an early warning when a target return period is met or exceeded by the prediction.

17. A server for providing alerts for rainfall return periods, comprising:
a communication interface operable to receive periodic rain intensity measurements from a pluviometer and to forward alerts to a remote terminal; and
a controller configured to:
compare a last received rain intensity measurement to a set of rainfall intensity-duration-frequency (IDF) curves for a location of the pluviometer and for a time window corresponding to a periodicity of the rain intensity measurements,
provide a current return period for the location of the pluviometer based on the comparison of the last received rain intensity measurement to the set of rainfall IDF curves,
generate an alert when at least one of one or more target return periods is met or exceeded by the current return period, and
instruct the communication interface to forward the generated alert to the remote terminal.

18. The server of claim 17, wherein the controller is further configured to:
calculate a prediction of a future return period for the location of the pluviometer based on the current return period;
generate an early warning when at least one of the one or more target return periods is met or exceeded by the prediction; and
instruct the communication interface to forward the generated early warning to the remote terminal.

19. The server of claim 18, comprising a timing unit, the controller being further configured to use timing information from the timing unit to integrate two or more periodic rain intensity measurements, to compare a result of the integration to the set of rainfall IDF curves for the location of the pluviometer and for a time window corresponding to a time span of the integration, to provide a recent return period for the location of the pluviometer, and to calculate the prediction of the future return period for the location of the pluviometer based on the current and recent return periods.

20. The server of claim 19, wherein the periodic rain intensity measurements are obtained at 5-minute intervals and wherein the controller is configured to integrate the periodic rain intensity measuring over periods ranging from 10 minutes to 24 hours.

21. The server of claim 18, wherein the communication interface is operable to receive successive wind intensity measurements, the server being further configured to accumulate the successive wind intensity measurements to issue a wind-related alert when an average of a predetermined number of the successive wind intensity measurements exceeds a predetermined threshold.

22. The server of claim 17, comprising a memory for storing the set of rainfall IDF curves, the last received rain intensity measurement, and previously received rain intensity measurements.

23. The server of claim 17, wherein the generated alert is forwarded to the remote terminal as a text message.

24. The server of claim 17, wherein the communication interface includes a first communication port for communicating with the pluviometer and a second communication port for communicating with the remote terminal.

25. The server of claim 17, comprising a graphical user interface configured for displaying accumulated rain intensity measurements in tabular form or in graphical form.

26. The server of claim 17, wherein:
the communication interface is further operable to receive weather-related radar images; and
the server is further configured to calibrate the radar images based on the periodic rain intensity measurements and to generate images providing return period information.

27. The server of claim 26, comprising a graphical user interface configured for displaying the generated images.

28. The server of claim 17, wherein the communication interface is operable to forward the generated alert to a plurality of remote terminals.

29. The server of claim 17, wherein the communication interface is operable to receive the periodic rain intensity measurements from a plurality of pluviometers, the controller being configured to generate a plurality of alerts based on the periodic rain intensity measurements received from the plurality of pluviometers.

30. The server of claim 17, wherein the communication interface is operable to receive snow accumulation measurements, the controller being further configured to adapt a received rain intensity measurement by applying a conversion factor to the snow accumulation measurement.
